(19) United States
(12) Patent Application Publication
(10) Pub. No.: US 2014/0207309 A1
(43) Pub. Date: Jul. 24, 2014

(54) VEHICLE DRIVER DETERMINATION AND BEHAVIOR MONITORING

(71) Applicant: CARTASITE, INC., Denver, CO (US)

(72) Inventors: David L. Armitage, Golden, CO (US); Gregory Froim Kushnir, Denver, CO (US); Mark Alvin Mason, Thornton, CO (US)

(73) Assignee: CARTASITE, INC., Denver, CO (US)

(21) Appl. No.: 14/221,511

(22) Filed: Mar. 21, 2014

Related U.S. Application Data
(63) Continuation-in-part of application No. 13/105,368, filed on May 11, 2011.
(60) Provisional application No. 61/333,448, filed on May 11, 2010.
(60) Provisional application No. 61/333,457, filed on May 11, 2010.

(51) Int. Cl. G07C 5/00

(52) U.S. Cl. CPC G07C 5/008
USPC 701/1

(57) ABSTRACT

What is disclosed are various methods, systems, and software for operating vehicle monitoring systems. Information is processed to determine the driver of a vehicle, if the driver is using a wireless device, and driving events.

### RELATED APPLICATIONS

This patent application is a continuation-in-part application of U.S. patent application Ser. No. 13/105,368, entitled “VEHICLE DRIVER BEHAVIOR MONITORING AND CORRELATION,” which is related to, and claims priority to, U.S. Provisional Patent Application No. 61/333,448, entitled “Correlation of Driver Behavior to Vehicle Activity,” filed on May 11, 2010, and U.S. Provisional Patent Application No. 61/333,457, entitled “Segment Based Driving Analysis and Reporting,” filed on May 11, 2010, which are hereby incorporated by reference in their entirety.

### TECHNICAL FIELD

Aspects of the disclosure are related to the field of vehicle monitoring systems, and in particular, vehicle monitoring systems to monitor, analyze, and determine the driver and to monitor and analyze vehicle behavior.

### TECHNICAL BACKGROUND

Performance monitoring tools are used to assess the operation of a vehicle, such as an automobile, airplane, or the like. These tools analyze the performance of the vehicle and the various internal systems which make up the vehicle. Assessments on performance may be achieved in both real time and non-real time manners.

Cars and vehicles may contain On Board Diagnostics (OBD) systems which provide some level of self-diagnostic and information reporting capability. OBD systems were originally developed to be used during the manufacturing and test processes. However, the capabilities of these systems and their uses have expanded dramatically since that time. Currently, OBD systems give repair technicians, vehicle owners, and emissions testing agencies electronic access to state of health and operational information pertaining to many different vehicle subsystems. Historically, many vehicle functions like braking, speed indication, and fuel delivery were performed by mechanical systems and components. Presently, many of these vehicle functions are controlled or monitored through electronic means, thereby making electronic information about the performance and operations of those systems readily available. It is now possible to electronically monitor tens, if not hundreds, of operational characteristics of a vehicle using OBD systems.

While OBD is a generic term referring to any of a class of systems which provide these reporting capabilities, there are industry standard implementations which provide for standardized connectors, pinouts, and signal characteristics, among other things. Currently, the most prevalent system is the OBDII system. OBDII provides access to a wide range of data from the engine control unit (ECU), and CAN bus, as well as other vehicle systems. The system offers standardized methods for requesting various diagnostic data as well as a list of standard parameters which may be available from an OBDII system.

Driver behavior and the potential for vehicle accidents has been a longstanding concern. In recent years, driver behavior has garnered additional attention in various media outlets. In particular, some media have reported on the impact of new communication technologies, such as cell phones and text messaging, on driver behavior. It has been shown that engaging with these technologies while operating a vehicle can have significant adverse effects. Consequently, business owners and government agencies that have drivers operating vehicles on their behalf have heightened concerns about the driving behaviors of their drivers and the ensuing risks which may be associated with those behaviors. Parents may be concerned about the driving behaviors of their children and wish to affect those driving behaviors for similar reasons.

In addition to affecting the risks of an accident, driver behavior may have other important cost and environmental impacts as well. If there are more than one personal communication devices used in the vehicle, it may be advantageous to determine the driver.

### OVERVIEW

What is disclosed are method, systems, and software for operating a vehicle monitoring system. One example includes a method of operating a vehicle monitoring system, including receiving activity information related to a vehicle at a vehicle monitor, wherein the vehicle monitoring system is adjacent the vehicle, receiving information from one or more wireless communication devices associated with the vehicle, and processing the activity information and the information from the one or more wireless communication devices to determine behavior of a driver operating the vehicle.

What is also disclosed is a vehicle monitoring system, which includes a communication interface configured to receive activity information for a vehicle from a vehicle monitor and/or a wireless communication device, where the communication interface configured to receive information from the one or more wireless communication devices associated with the vehicle transferred by a communication network, and a processing system configured to process the activity information and the information from the one or more wireless communication devices to determine behavior of a driver operating the vehicle.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a vehicle monitoring system, according to an example.

FIG. 2 is a flow diagram illustrating an example method of operating a vehicle monitoring system.

FIG. 3 is a system diagram illustrating an example vehicle monitoring system.

FIG. 4 is a flow diagram illustrating a method of operating a vehicle monitoring system, according to an example.

FIG. 5 is a block diagram illustrating a collection node, according to an example.

FIG. 6 is a block diagram illustrating a wireless communication device, according to an example.

FIG. 7 is a block diagram illustrating a vehicle monitor, according to an example.

### DETAILED DESCRIPTION

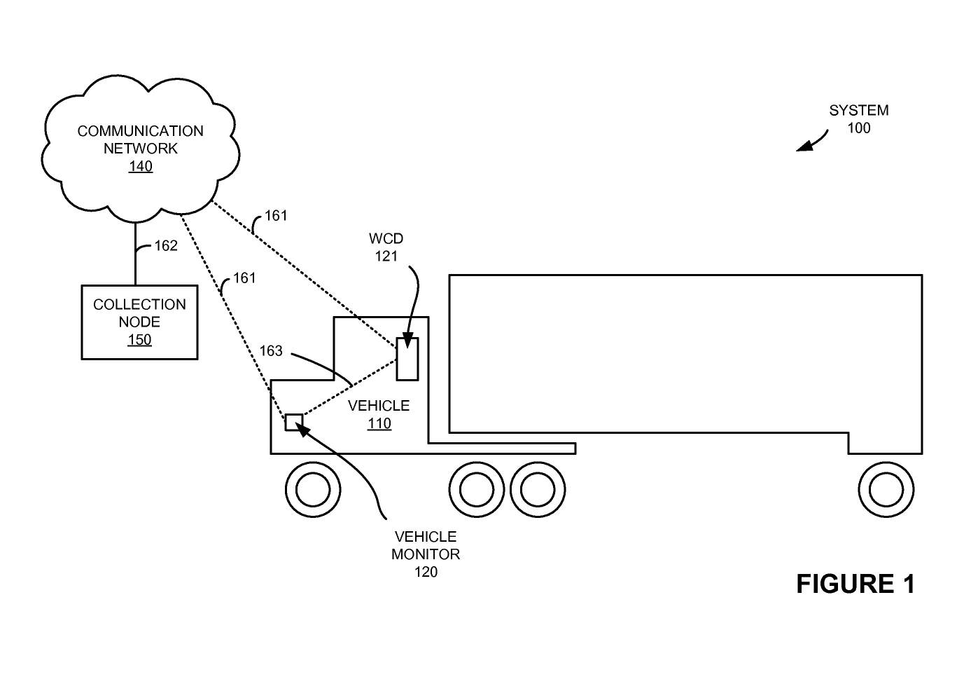

FIG. 1 is a system diagram illustrating vehicle monitoring system 100. System 100 includes vehicle 110, vehicle monitor 120, wireless communication device 121, communication network 140, and collection node 150. Wireless communication device 121, vehicle monitor 120, and communication network 140 communicate over wireless link 161. Communication network 140 and collection node 150 communicate over link 162.

Vehicle 110 is shown as a semi-trailer and tractor in this example. However, in other examples, vehicle 110 could instead be a different vehicle, such as a passenger car, passenger vehicle, flatbed vehicle, construction vehicle, railway car, or any other vehicle. Vehicle 110 includes vehicle monitor 120 and wireless communication device 121.

In an example, vehicle monitor 120 is coupled to the vehicle 110. In this example, vehicle monitor 120 is coupled electrically to vehicle 110 through a vehicle interface (not shown) to monitor engine performance and receive information from the various systems associated with vehicle 110. The vehicle interface could include an OBD vehicle interface and could include information from the CAN bus.

Vehicle monitor 120 could also include a sensor portion, which could include thermometers, thermocouples, thermopiles, emitters/detectors, microphones, accelerometers, strain gauges, flow gauges, chemical sensors, micro-electromechanical system (MEMS) sensors, electrical sensors, among other sensing equipment and circuitry.

Vehicle monitor 120 could also include a transceiver portion for communication with collection node 150 via communication link 161 and communication network 140. Vehicle monitor 120 is also capable of communicating with wireless communication device 121 via communication link 163. Vehicle monitor 120 is also capable of communicating with wireless communication device 121 via cellular, Bluetooth, or any other type of communication.

In some examples, the transceiver portion includes a wireline transceiver for communicating over a wire, optical fiber, or other medium. In other examples, the transceiver portion includes a wireless transceiver and antenna. Vehicle monitor 120 could also include a processing portion for receiving sensor and vehicle information, amplifying, scaling, modifying, adjusting, digitizing, or converting the information, as well as for controlling the transceiver portion and sensor portions. Vehicle monitor 120 could also comprise a power system, such as a battery or solar cell, or be powered by the OBD port of the vehicle.

Vehicle monitor 120 could also comprise a global positioning system (GPS) receiver, to receive and interpret signals from positioning satellites to determine geographic coordinates. In an example, vehicle monitor 120 includes an accelerometer, GPS functionality, flash memory, a processor, a real-time operating system, as well as cellular and Bluetooth-type communication capabilities.

In operation, vehicle monitor 120 senses and monitors equipment associated with vehicle 110. The information monitored could include engine component temperature, ambient temperature, vibration, noise, acceleration, position, fuel usage, oxygen usage, emissions, braking, direction, steering, incline, engine start/stop status, transmission status, tire pressure, among other information.

Vehicle monitor 120 is also configured to collect, store, and transfer the monitored information about vehicle 110 from the vehicle 120 and from wireless communication device 121. In some examples, vehicle monitor 120 is configured to wirelessly transmit the collected information to collection node 150, such as over a wireless communication network or satellite communication network 140 while vehicle 110 is in motion.

In other examples, vehicle monitor 120 is coupled via a wireless or wireline interface to collection node 150 while vehicle 110 is not in motion to transfer information collected and stored over a period of time, such as after a roundtrip delivery. Vehicle monitor 120 could also collect, store, and report other information, such as position, time, battery life, sensor status, inoperative sensors, serial numbers, equipment identifiers, among other information. Vehicle monitor 120 could also collect, store, and report other information from wireless communication device 121, such as acceleration information, blue-tooth signal strength, user interaction information, application information, GPS information, camera information, information from the microphone, or any other information discernible from wireless communication device 121. vehicle monitor 120 may also include a processor and may accomplish some or all of the functionality described within this disclosure.

Wireless communication device 121 is a mobile wireless multi-function telephone (smartphone) in this example. Wireless communication device 121 comprises radio frequency (RF) communication circuitry and antenna elements. The RF communication circuitry typically includes amplifiers, filters, modulators, and signal processing circuitry. In many examples, wireless communication device 121 includes circuitry and equipment to exchange communications of wireless communication services over wireless links, as provided by base stations associated with communication network 140. Wireless communication device 121 may also include user interface systems, memory devices, non-transient computer-readable storage mediums, software, processing circuitry, cameras, sensor systems, accelerometers, compasses, GPS receivers, or other communication and circuitry components. Wireless communication device 121 is capable of cellular and Bluetooth-type communication, among many others.

Wireless communication device 121 may also be another wireless communication device, such as subscriber equipment, customer equipment, access terminal, computer, e-book, mobile Internet appliance, wireless network interface card, media player, game console, or some other wireless communication apparatus, including combinations thereof. Although one wireless communication device is shown in FIG. 1, it should be understood that a different number of wireless communication devices could be shown within vehicle 120.

Wireless communication device 121 could include complementary or additional sensors, equipment, and circuitry as to vehicle monitor 120 or collection node 150. In some examples, vehicle monitor 120 or collection node 150 are not employed, and only wireless communication device 121 is employed. Specialized software or circuitry could be employed in wireless communication device 121 to operate as described herein for vehicle monitoring system 121 or collection node 150.

Communication network 140 could include base stations, base station control systems, Internet access nodes, telephony service nodes, wireless data access points, routers, gateways, satellite systems, or other wireless communication systems, including combinations thereof. Communication network 140 may also comprise optical networks, asynchronous transfer mode (ATM) networks, packet networks, metropolitan-area networks (MAN), or other network topologies, equipment, or systems, including combinations thereof. In typical examples, communication network 140 includes many base stations and associated equipment for providing communication services to many wireless and mobile devices across a geographic region. In the example shown in FIG. 1, communication network 140 provides wireless communication service to wireless communication device 140, such as cellular service, over a geographic area. Systems in communication network 140 also track and store usage information for wireless communication device 121, such as call records, usage history, text message records, data usage, among other usage information.

Collection node 150 comprises equipment for receiving and accumulating information about vehicle 110 and wireless communication device 121. In some examples, the information is received from communication network 140 over link 162, while in other examples, the information is received over other communication pathways. Collection node 150 also includes communication interfaces, as well as a computer system, microprocessor, circuitry, or some other processing device or software system, and may be distributed among multiple processing devices. Examples of collection node 150 may also include software such as an operating system, logs, utilities, drivers, networking software, and other software stored on a non-transient computer-readable medium. Collection node 150 could also include application servers, application service provider systems, database systems, logistics systems, web servers, or other systems. Collection node 150 could collect vehicle and wireless communication device information from many vehicles and wireless communication devices.

Wireless link 161 uses the air or space as the transport media. Wireless link 161 may use various protocols, such as Code Division Multiple Access (CDMA), Evolution-Data Optimized (EV-DO), single-carrier radio transmission technology link (1×RTT), Worldwide Interoperability for Microwave Access (WIMAX), Global System for Mobile Communication (GSM), Universal Mobile Telecommunications System (UMTS), Long Term Evolution (LTE), Wireless Fidelity (Wi-Fi), High Speed Packet Access (HSPA), Radio Link Protocol (RLP), satellite phone communications, or some other wireless communication format, including combinations, improvements, or variations thereof.

Communication link 162 uses various communication media, such as air, space, metal, optical fiber, or some other signal propagation path, including combinations thereof. Communication link 162 could use various communication protocols, such as Internet Protocol (IP), Ethernet, Wireless Fidelity (Wi-Fi_{—}33), Bluetooth, Controller Area Network (CAN) bus, Inter-Integrated Circuit (I2C), 1-Wire, Radio Frequency Identification (RFID), Time Division Multiplex (TDM), asynchronous transfer mode (ATM), optical, synchronous optical networking (SONET), circuit-switched, communication signaling, or some other communication format, including combinations, improvements, or variations thereof. Communication link 162 could be a direct link or may include intermediate networks, systems, or devices. In some examples, communication link 162 operates using wireless protocols as described for wireless link 161.

Links 161-163 may each include many different signals sharing the same link—as represented by the associated lines in FIG. 1—comprising access channels, forward links, reverse links, user communications, communication sessions, overhead communications, frequencies, other channels, carriers, timeslots, spreading codes, transportation ports, logical transportation links, network sockets, packets, or communication directions.

In an example, there may be one or more wireless communication devices 121 adjacent or in vehicle 11. Vehicle monitor 120 and the various wireless communication devices 121 may have Bluetooth or other wireless capabilities and may be capable of communicating with each other. Vehicle monitor 120 may determine the driver of the vehicle based at least in part on signal strength from the various wireless communication devices 121 and/or the relative positions of the users and/or the wireless communication devices 121. In another example vehicle monitor 120 may be able to sense the signal strength from the wireless communication devices 121, and may make a determination of the driver based at least in part on the signal strengths.

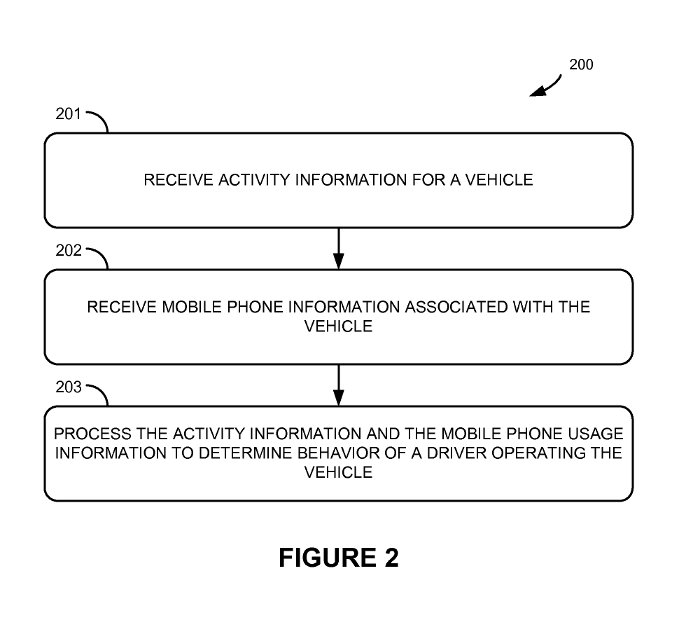

FIG. 2 is a flow diagram illustrating a method 200 of operating vehicle monitoring system 100. The operations in FIG. 2 are referenced herein parenthetically. In FIG. 2, collection node 150 or vehicle monitor 120 receives (201) activity information for a vehicle. In this example, the vehicle is vehicle 110. The information about the activities of vehicle 110 could be determined by vehicle monitor 120 or by wireless communication device 121. The vehicle information could include a likely driver, engine component temperature, ambient temperature, vibration, noise, acceleration, position, fuel usage, oxygen usage, emissions, braking, direction, steering, incline, engine start/stop status, transmission status, tire pressure, position, time, battery life, sensor status, inoperative sensors, serial numbers, or other identifiers, among other information.

Collection node 150 receives (202) wireless communication device 121 information associated with the vehicle 120. The information of wireless communication device 121 could include voice call records, usage history, text message records, Internet usage, information about application usage, or data usage, among other usage information. In an example, communication network 140 may track the usage information for wireless communication device 121 and provides the additional usage information to collection node 150 over link 162.

Collection node 150 processes (203) the activity information and the wireless communication device usage information to determine behavior of a driver operating the vehicle 120. Collection node 150 can process the activity information received about vehicle 110 and the usage information for phone 121 to determine the wireless communication device 121 associated with the driver, and the driving behavior during driving incidents.

For example, the activity information received about vehicle 110 and the usage information for phone 121 could be processed to determine if the driver of vehicle 110 was engaged in a phone call or text message on a wireless communication device 121 generally associated with the driver during the occurrence of a driving incident.

A driving incident or driving event could include a hard braking event, an accident, a sudden directional change, a flat tire, among other events. The driving event could be determined by processing the vehicle information received about vehicle 110, such as by processing an acceleration/deceleration, a tire pressure event, engine start/stop events, or a timestamp, among other information. These driving events could then be correlated to activity of one or more wireless communication devices 121 adjacent or associated with vehicle 110.

As discussed above, further information, such as activity records of wireless communication device 121 could be obtained by collection node 150. These activity records could be provided to collection node 150 by a communication service provider of wireless communication device 121, such as phone records from a phone company, cellular provider, information service provider, information collection agency, among others providers. In some examples, a call database or call history record is obtained from communication network 140 for activity of wireless communication device 121. These activity records of wireless communication device 121 could also include a timestamp and date to indicate when each activity occurred and location information, among other information.

In some examples, more than one wireless communication device or wireless communication device is located within vehicle 110, such as if a passenger was present with a wireless communication device. In examples with more than one wireless communication device, collection node 150 may have difficulty determining which person in vehicle 110 was engaging in activity on a wireless communication device during a driving event. Collection node 150 could then process other additional information to determine if the driver of vehicle 110 was using wireless communication device 121 during a driving event. Signal strength of the wireless communication devices 121, GPS information of the wireless communication devices 121, and other information from the wireless communication devices 121 may be used. Multiple pieces of information could be collected and compared to determine a score, and the score could indicate the most likely wireless device associated with the driver of vehicle 110 based upon many factors.

In some examples, activity of a wireless headset interface of vehicle 110 could be processed to identify the driver of vehicle 110, such as when a wireless headset, such as a Bluetooth headset, is in use or when a headset has been synchronized to a wireless communication device associated with a particular driver. For example, the driver may have registered the wireless headset interface of vehicle 110 with wireless communication device 121, and when the wireless headset interface is in use, collection node 150 could determine that the driver, not a passenger, was engaged in activity with wireless communication device 121. Bluetooth signal strength measured at vehicle monitor 120 may also be used to determine the particular wireless communication device 121 generally associated with the driver of the vehicle.

In other examples, information from other sources, other than the wireless communication device generally associated with the driver, or the vehicle monitor may be used, at least in part, to better determine a like wireless communication device associated with the driver of the vehicle. This other information may include any listed within the disclosure or any other information.

In an example, past driving patterns or driving history of the driver could be analyzed by collection node 150 to identify a driver of driving vehicle 110. Driving habits could be determined by collecting and storing past activity information of vehicle 110, or other vehicles, for a set of multiple drivers, and processing the past activity information to create driver profiles. For example, a driver may accelerate or brake in a particular pattern or within a range of magnitudes, and the habits of different drivers can thus be differentiated.

In yet further examples, biometric sensors could be used to differentiate drivers of vehicle 110, such as facial recognition, fingerprint sensors, weight or weight distribution on a seat, among other biometrics. In other examples, a driver must sign in, log in, or otherwise identify him or herself as the current driver of vehicle 110, such as entering credentials via a smartcard or login/password combination.

In even further examples, when vehicle monitor 120 and wireless communication device 121 each include acceleration sensors, the acceleration data could be compared between vehicle monitor 120 and wireless communication device 121, or among multiple wireless communication devices within vehicle 110. During acceleration events, such as turns, cornering, bumps, or other events, differences in acceleration among the various devices can indicate a position within vehicle 110. The driver could then be identified based upon the position of the device.

For example, during a cornering event, vehicle monitor 120 and wireless communication device 121 may each experience different accelerations or force differences, even if for a brief portion of the cornering event. Additionally, a difference in the phase of acceleration, such as differing delays experienced by different wireless communication devices or vehicle monitoring system could differentiate positioning within vehicle 110. Information such as the center of mass of vehicle 110, a characterized behavior of vehicle 110 during cornering events, the masses of vehicle 110, vehicle monitor 120, or wireless communication device 121, a predetermined position of vehicle monitor 120, or other factors, could be processed along with the accelerations experienced by vehicle monitor 120 and wireless communication device 121 to determine a likely position of wireless communication device 121 relative to vehicle monitor 120 or other wireless communication devices in vehicle 110. In examples where vehicle monitor 120 and wireless communication device 121 each include a GPS receiver, a position of wireless communication device 121 could be determined relative to a known or predetermined location of vehicle monitor 120 in vehicle 110. The correlation of wireless communication device 121 to a driver of vehicle 110 could then be determined based upon the physical location of wireless communication device 121 within vehicle 110. For example, if wireless communication device 121 is located near to the driver's seat or body during use of wireless communication device 121, then collection node 150 could determine that the driver is associated with wireless communication device 121 at that time.

Additionally, collection node 150 could process the information received about vehicle 110 and the usage information for phone 121 to determine a driver of vehicle 110 to associate different drivers with trips or routes from a trip log. Trip reports or logs as created by drivers or logging systems could be compared to a driver identified as described above. The trip reports could be audited to ensure that the driver indicated on the trip report correlates to the driver identified as the driver of vehicle 110. For example, if the driver of vehicle 110 is correlated to wireless communication device 121 as described above, the trip report can be audited to determine if the proper driver was associated with the trip. Also, as discussed above, past driving patterns or driving history of drivers could be analyzed by collection node 150 to identify a driver of driving vehicle 110. Driving habits could be determined by collecting past activity information on vehicle 110 or other vehicles for a set of multiple drivers, and processing the past activity information to create driver profiles. For example, some drivers accelerate or brake in a particular pattern or within a range of magnitudes, have similar start and stop locations (i.e. certain fuel stations or eating locations and times), or have other habits, and different drivers can thus be differentiated. In other examples, the driving data could be processed to determine if a driver decelerates, such as pulling over to the side of a roadway, when engaged in activity with wireless communication device 121, such as when an incoming call is received.

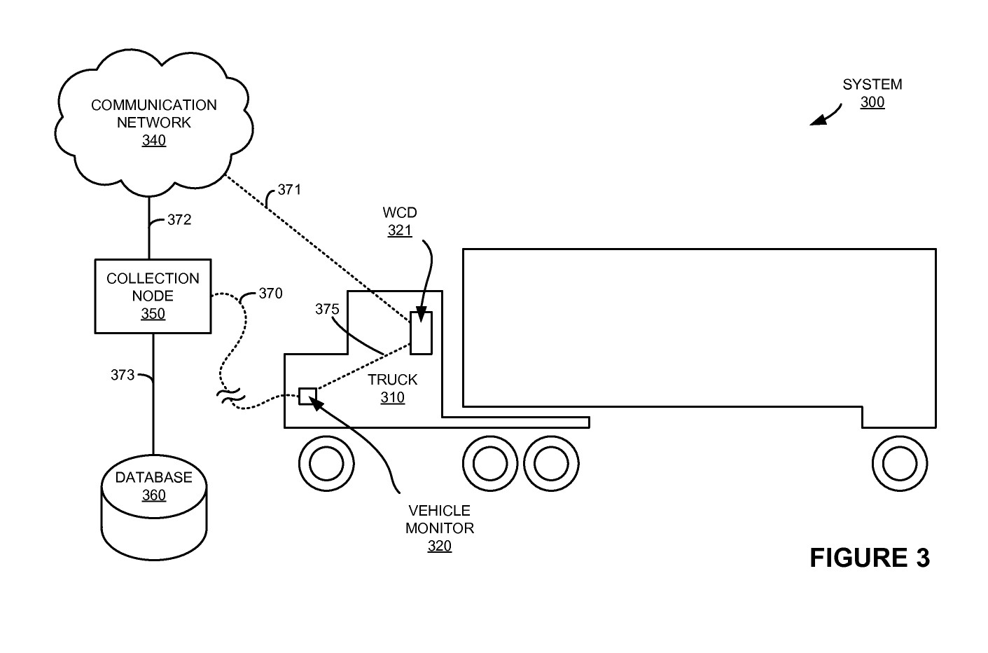

FIG. 3 is a system diagram illustrating an example vehicle monitoring system 300. System 300 may include some or all of: vehicle 310, vehicle monitor 320, wireless communication device 321, communication network 340, collection node 350, and database 360. Wireless communication device 321 and communication network 340 communicate over wireless link 371. Communication network 340 and collection node 350 communicate over link 372. Collection node 350 and database 360 communicate over link 373. Collection node 350 and vehicle monitor 320 communicate over link 370, although link 370 may not be connected during operation of vehicle 310 in all examples. Wireless communication devices 321 may communicate with vehicle monitor 320 at least in part via communication link 375.

Vehicle 310 is shown as a semi-trailer and tractor in this example. However, in other examples, vehicle 310 could instead be a different vehicle, such as a passenger car, passenger vehicle, flatbed vehicle, construction vehicle, railway car, or other vehicle. Vehicle 310 includes vehicle monitor 320 and wireless communication device 321.

Vehicle monitor 320 is coupled to the engine of vehicle 310. In this example, vehicle monitor 320 is coupled electrically to vehicle 310 through a vehicle interface (not shown) to monitor engine performance and receive information from the various systems associated with vehicle 310. The vehicle interface could include an OBD vehicle interface for power but not for information. Vehicle monitor 320 could also comprise a global positioning system (GPS) receiver, to receive and interpret signals from positioning satellites to determine geographic coordinates. Vehicle monitor 320 could also include a sensor portion, comprising thermometers, thermocouples, thermopiles, emitters/detectors, microphones, accelerometers, strain gauges, flow gauges, chemical sensors, micro-electromechanical system (MEMS) sensors, compasses, electrical sensors, among other sensing equipment and circuitry. Vehicle monitor 320 could also include a transceiver portion for communication with collection node 350 over link 370, and for communicating with wireless communication devices 321 located generally near vehicle monitor 320.

Vehicle monitor 320 could also include Bluetooth sensing and/or communication capability, an accelerometer, GPS functionality, cellular communication capability, flash memory, a processor, a real-time operating system, along with other functionality. Vehicle monitor 320 may also include a sensor to sense signal strength from one or more wireless communication devices 321.

In some examples, the transceiver portion includes a wireline transceiver for communicating over a wire, optical fiber, or other medium. In other examples, the transceiver portion includes a wireless transceiver and antenna, such as cellular, Bluetooth, satellite, or other communication capability. Vehicle monitor 320 could also include a processing portion for receiving sensor and vehicle information, amplifying, scaling, modifying, adjusting, digitizing, or converting the information, as well as for controlling the transceiver portion and sensor portions. The processor portion may be capable of accomplishing all of the functionality described for any processing system described in this disclosure. Vehicle monitor 320 could also comprise a power system, such as a battery or solar cell.

In operation, vehicle monitor 320 senses and monitors equipment associated with vehicle 310. The information monitored could include geographic position, engine component temperature, ambient temperature, vibration, noise, acceleration, fuel usage, oxygen usage, emissions, braking, direction, steering, incline, engine start/stop status, transmission status, tire pressure, among other information. Vehicle monitor 320 is also configured to collect, store, and transfer the monitored information about vehicle 310.

In some examples, vehicle monitor 320 is configured to wirelessly transmit the collected information to collection node 350, such as over a wireless communication network or satellite communication network while vehicle 310 is in motion. In other examples, vehicle monitor 320 is coupled via a wireless or wireline interface to collection node 350 while vehicle 310 is not in motion to transfer information collected and stored over a period of time, such as after a roundtrip delivery. Vehicle monitor 320 could also collect, store, and report other information, such as position, time, battery life, sensor status, inoperative sensors, serial numbers, equipment identifiers, among other information.

Wireless communication device 321 is a multi-function mobile wireless telephone (smartphone) in this example. Wireless communication device 321 comprises radio frequency (RF) communication circuitry and antenna elements. The RF communication circuitry typically includes amplifiers, filters, modulators, and signal processing circuitry. In many examples, wireless communication device 321 includes circuitry and equipment to exchange communications of wireless communication services over wireless links, as provided by base stations associated with communication network 340.

Wireless communication device(s) 321 may also include user interface systems, memory devices, computer-readable storage mediums, software, processing circuitry, cameras, sensor systems, accelerometers, compasses, GPS receivers, or other communication and circuitry components. Wireless communication device 321 may also be another wireless communication device, such as subscriber equipment, customer equipment, access terminal, computer, e-book, mobile Internet appliance, wireless network interface card, media player, game console, or some other wireless communication apparatus, including combinations thereof. Although one wireless communication device is shown in FIG. 3, it should be understood that a different number of wireless communication devices could be shown.

Wireless communication device 321 could include complementary or additional sensors, equipment, and circuitry as to vehicle monitor 320 or collection node 350. In some examples, vehicle monitor 320 or collection node 350 are not employed, and only wireless communication device 321 is employed. Specialized software or circuitry could be employed in wireless communication device 321 to operate as described herein for vehicle monitoring system 323 or collection node 350.

Communication network 340 could include base stations, base station control systems, Internet access nodes, telephony service nodes, wireless data access points, routers, gateways, satellite systems, or other wireless communication systems, including combinations thereof. Communication network 340 may also comprise optical networks, asynchronous transfer mode (ATM) networks, packet networks, metropolitan-area networks (MAN), or other network topologies, equipment, or systems, including combinations thereof. In typical examples, communication network 340 includes many base stations and associated equipment for providing communication services to many wireless and mobile devices across a geographic region. In the example shown in FIG. 3, communication network 340 provides wireless communication service to wireless communication device 340, such as cellular service, over a geographic area. Systems in communication network 340 also track and store usage information for wireless communication device 321, such as call records, usage history, text message records, data usage, among other usage information.

Collection node 350 comprises equipment for receiving vehicle information about vehicle 310. In some examples, the vehicle information is received from communication network 340 over link 372, while in other examples, the information is received over other communication pathways. Collection node 350 also includes equipment for receiving estimated transit times from database 360 over link 373. Collection node 350 could comprise communication interfaces, as well as a computer system, microprocessor, circuitry, or some other processing device or software system, and may be distributed among multiple processing devices. Examples of collection node 350 may also include software such as an operating system, logs, utilities, drivers, networking software, and other software stored on a computer-readable medium. Collection node 350 could also include application servers, application service provider systems, database systems, logistics systems, web servers, or other systems. Collection node 350 could collect vehicle and wireless communication device information from many vehicles and wireless communication devices.

Communication links 370 and 375 may use various communication media, such as air, space, metal, optical fiber, or some other signal propagation path, including combinations thereof. Communication links 370 and 375 could use various communication protocols, such as Internet Protocol (IP), Ethernet, Wireless Fidelity (Wi-Fi_{—}33), Bluetooth, Controller Area Network (CAN) bus, Inter-Integrated Circuit (I2C), 3-Wire, Radio Frequency Identification (RFID), optical, circuit-switched, communication signaling, or some other communication format, including combinations, improvements, or variations thereof. Communication link 370 could be a direct link or may include intermediate networks, systems, or devices. In some examples, communication link 370 operates wirelessly using wireless protocols as described for wireless link 371.

Wireless link 371 uses the air or space as the transport media. Wireless link 371 may use various protocols, such as Code Division Multiple Access (CDMA), Evolution-Data Optimized (EV-DO), single-carrier radio transmission technology link (3×RTT), Worldwide Interoperability for Microwave Access (WIMAX), Global System for Mobile Communication (GSM), Universal Mobile Telecommunications System (UMTS), Long Term Evolution (LTE), Wireless Fidelity (Wi-Fi_{—}33), High Speed Packet Access (HSPA), Radio Link Protocol (RLP), satellite phone communications, or some other wireless communication format, including combinations, improvements, or variations thereof.

Communication links 372-373 each use various communication media, such as air, space, metal, optical fiber, or some other signal propagation path, including combinations thereof. Communication links 372-373 could each use various communication protocols, such as Internet Protocol (IP), Ethernet, Wireless Fidelity (Wi-Fi_{—}33), Time Division Multiplex (TDM), asynchronous transfer mode (ATM), optical, synchronous optical networking (SONET), circuit-switched, communication signaling, or some other communication format, including combinations, improvements, or variations thereof. Communication links 372-373 each could be a direct link or may include intermediate networks, systems, or devices. In some examples, communication links 372-373 each operate wirelessly using wireless protocols as described for wireless link 371.

Links 370-373, 375 may each include many different signals sharing the same link—as represented by the associated lines in FIG. 3—comprising access channels, forward links, reverse links, user communications, communication sessions, overhead communications, frequencies, other channels, carriers, timeslots, spreading codes, transportation ports, logical transportation links, network sockets, packets, or communication directions.

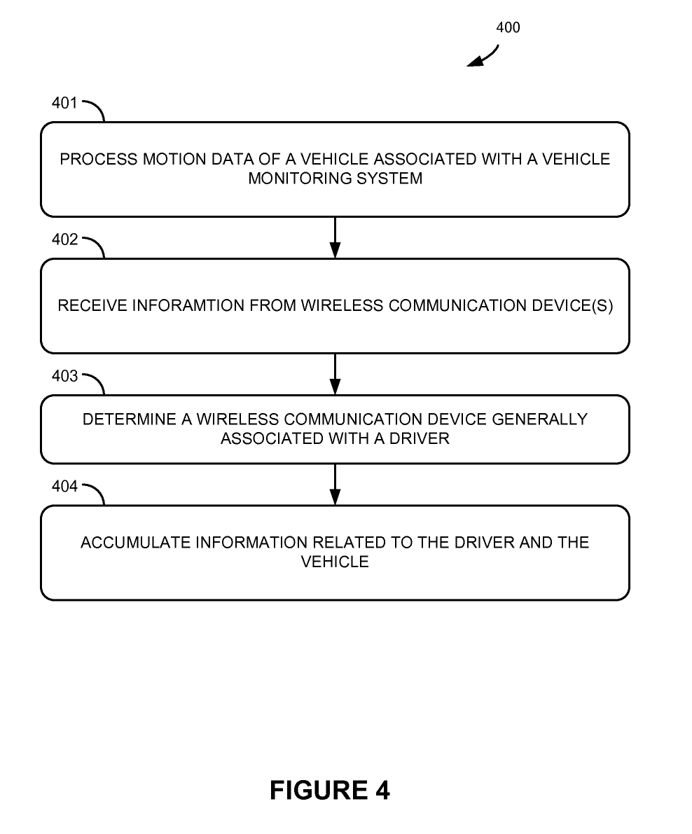

FIG. 4 is a flow diagram illustrating a method of operating vehicle monitoring system 300 and/or 100. The operations of FIG. 4 are referenced herein parenthetically. In FIG. 4, collection node 350 or vehicle monitor 320 processes (401) data of a vehicle associated with vehicle monitor 320. In this example, the vehicle is vehicle 310. Collection node 350 receives information about the activities of vehicle 310. The information about the activities of vehicle 310 could be determined by vehicle monitor 320 or by wireless communication device 321. In some examples, collection node 350 receives the information from vehicle monitor 320 over link 370. In other examples, collection node 350 receives the information from wireless communication device 321 over wireless link 371. The vehicle information could include vehicle motion data or position information for vehicle 310, such as time, distance, velocity, acceleration, direction, geographic coordinates correlated to time, among other vehicle position information, and signal strength from one or more wireless communication devices 321. The vehicle information could also include vehicle performance information, such as engine component temperature, ambient temperature, vibration, noise, fuel usage, oxygen usage, emissions, braking, steering position, incline, engine start/stop status, transmission status, tire pressure, time, battery life, sensor status, inoperative sensors, serial numbers, or other vehicle performance information.

Collection node 350 and/or vehicle monitor 320 can receive information from one or more wireless communication devices 321 (402). The information may include activity records of wireless communication device 321, which could include a timestamp and date to indicate when each activity occurred and location information, among other information. Information from wireless communication devices 321 could also include information from accelerometers, camera, temperatures, GPS information, device orientation information, or any other information capable of being sensed relating to wireless communication devices 321.

Collection node 350, and/or vehicle monitor 320 may determine a wireless communication device generally associated with the driver of the vehicle (403). This determination may be based at least in part on the vehicle activity information, information from the wireless communication devices 321, and/or other information as described throughout this disclosure. The determination may be an indication of the most likely wireless communication device associated with a driver. The determination may be a weighted average of many or the most important information received.

Information related to the driver and the vehicle may be accumulated (404). This information may include wireless communication device usage, driving events, driver or driving behaviors, etc. Reports and notifications may be generated from the accumulated information.

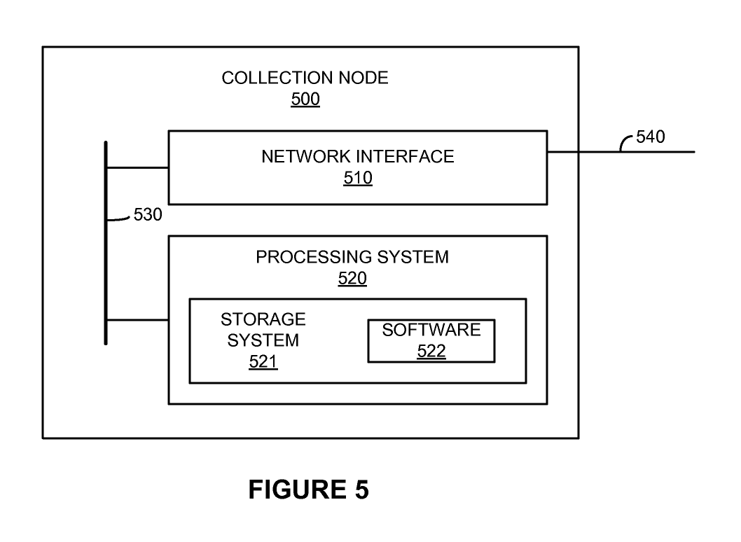

FIG. 5 is a block diagram illustrating collection node 500, as an example of collection node 150 found in FIG. 1 or collection node 350 found in FIG. 3, although collection node 150 or collection node 350 could use other configurations. Collection node 500 includes network interface 510 and processing system 520. Network interface 510 and processing system 520 communicate over bus 530. Collection node 500 may be distributed among multiple devices that together form elements 510, 520-522, 530, and 540.

Network interface 510 comprises network router and gateway equipment for communicating with a core network of a communication provider, such as with communication network 140 or communication network 340. Network interface 510 exchanges communications over link 540. Link 540 could use various protocols or communication formats as described herein for links 161-163 or 370-373, 375, including combinations, variations, or improvements thereof.

Processing system 520 includes storage system 521. Processing system 520 retrieves and executes software 522 from storage system 521. In some examples, processing system 520 is located within the same equipment in which network interface 510 is located. In further examples, processing system 520 comprises specialized circuitry, and software 522 or storage system 521 could be included in the specialized circuitry to operate processing system 520 as described herein.

Storage system 521 could include a non-transient computer-readable medium such as a disk, tape, integrated circuit, server, or some other memory device, and also may be distributed among multiple memory devices. Software 522 may include an operating system, logs, utilities, drivers, networking software, and other software typically loaded onto a computer system. Software 522 could contain an application program, firmware, or some other form of computer-readable processing instructions. When executed by processing system 520, software 522 directs processing system 520 to operate as described herein, such as receive vehicle activity information and wireless communication device usage information, process the information to determine driver behavior during driving events, or identify a driver and/or a wireless device likely to be associated with the river of a vehicle.

Bus 530 comprises a physical, logical, or virtual communication and power link, capable of communicating data, control signals, power, and other communications. In some examples, bus 530 is encapsulated within the elements of network interface 510 or processing system 520, and may include a software or logical link. In other examples, bus 530 uses various communication media, such as air, space, metal, optical fiber, or some other signal propagation path, including combinations thereof. Bus 530 could be a direct link or might include various equipment, intermediate components, systems, and networks.

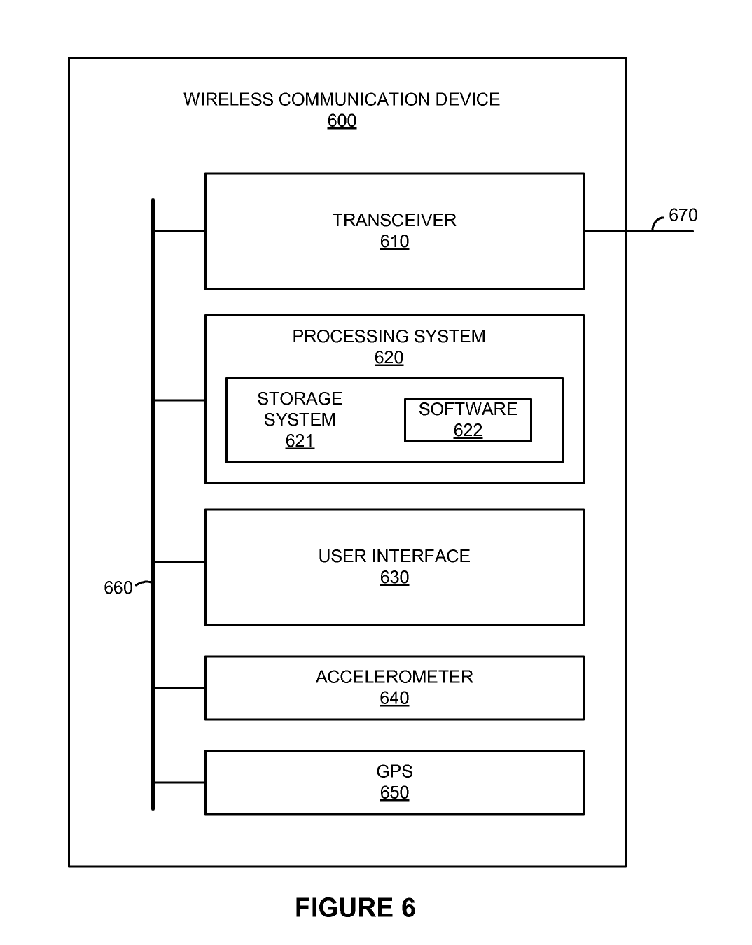

FIG. 6 is a block diagram illustrating wireless communication device 600, as an example of wireless communication device 121 found in FIG. 1 or wireless communication device 321 found in FIG. 3, although wireless communication device 121 or wireless communication device 321 could use other configurations. Wireless communication device 600 includes transceiver 610, processing system 620, user interface 630, accelerometer 640, and global positioning system (GPS) receiver 650. Transceiver 610, processing system 620, user interface 630, accelerometer 640, and GPS 650 communicate over bus 660. Wireless communication device 600 may be distributed or consolidated among devices that together form elements 610, 620-622, 630, 640, 650, 660, and 670.

Transceiver 610 comprises radio frequency (RF) communication circuitry and antenna elements. Transceiver 610 could also include amplifiers, filters, modulators, and signal processing circuitry. In this example, transceiver 610 can exchange instructions and information with processing system 620. Transceiver 610 also communicates with wireless access nodes and systems, such as base stations, omitted for clarity, over wireless link 670, to access communication services and exchange communications of the communication services. Wireless link 670 could use various protocols or communication formats as described herein for wireless link 161 or 370-371, 375, including combinations, variations, or improvements thereof. Device 600 and/or transceiver portion 610 may also include Bluetooth capability.

Processing system 620 includes storage system 621. Processing system 620 retrieves and executes software 622 from storage system 621. Processing system 620 could incorporate a computer microprocessor, logic circuit, or some other processing device, and may be distributed among multiple processing devices. Processing system 620 could be located within the same equipment or circuitry in which transceiver 610, user interface 630, accelerometer 640, or GPS 650 are located. Storage system 621 could include computer-readable media such as disks, tapes, integrated circuits, servers, or some other memory device, and also may be distributed among multiple memory devices.

Software 622 may include an operating system, logs, utilities, drivers, networking software, and other software typically loaded onto a computer system. Software 622 could contain an application program, firmware, or some other form of computer-readable processing instructions. When executed by processing system 620, software 622 directs wireless communication device 600 to operate as described herein to access a communication services through a wireless access system in coordination with transceiver 610, as well as determine or receive vehicle activity information and wireless communication device usage information, process the information to determine driver behavior during driving events, or identify a driver and/or identify a wireless communication device generally associated with a driver of a vehicle.

User interface 630 includes equipment and circuitry for receiving user input and control. Examples of the equipment and circuitry for receiving user input and control include push buttons, touch screens, selection knobs, dials, switches, actuators, keys, keyboards, pointer devices, microphones, transducers, potentiometers, non-contact sensing circuitry, or other human-interface equipment. User interface 630 also includes equipment to communicate information to a user of wireless communication device 600. Examples of the equipment to communicate information to the user could include indicator lights, lamps, light-emitting diodes, displays, haptic feedback devices, audible signal transducers, speakers, buzzers, alarms, vibration devices, or other indicator equipment, including combinations thereof.

Accelerometer 640 includes circuitry to detect and monitor acceleration of wireless communication device 600. This circuitry could include sensors, micro-electromechanical sensors (MEMS), optics, gyroscopes, inertial masses, amplifiers, conditioners, analog-to-digital converters, digital-to-analog converters, logic, or microprocessors, among other circuitry. Accelerometer 640 provides acceleration information over bus 650 to processing system 620 or transceiver 610.

Global positioning system (GPS) receiver 650 includes circuitry and antennas to receive and interpret signals from positioning satellites to determine geographic coordinates of wireless communication device 600. This circuitry could include sensors, amplifiers, conditioners, analog-to-digital converters, digital-to-analog converters, logic, or microprocessors, among other circuitry. GPS 650 provides positioning or location information over bus 650 to processing system 620 or transceiver 610.

Bus 660 comprises a physical, logical, or virtual communication link, capable of communicating data, control signals, communications, and power, along with other information and signals. In some examples, bus 660 is encapsulated within the elements of transceiver 610, processing system 620, user interface 630, accelerometer 640, or GPS 650, and may be a software or logical link. In other examples, bus 660 uses various communication media, such as air, space, metal, optical fiber, or some other signal propagation path, including combinations thereof. Bus 660 could be a direct link or might include various equipment, intermediate components, systems, and networks.

Wireless communication device 600 may also include camera functionality and other sensors, which may provide information generally about wireless communication device 600. Wireless communication device 600 may also be capable of accomplishing some or all of the functionality of collection node 150 found in FIG. 1 or collection node 350.

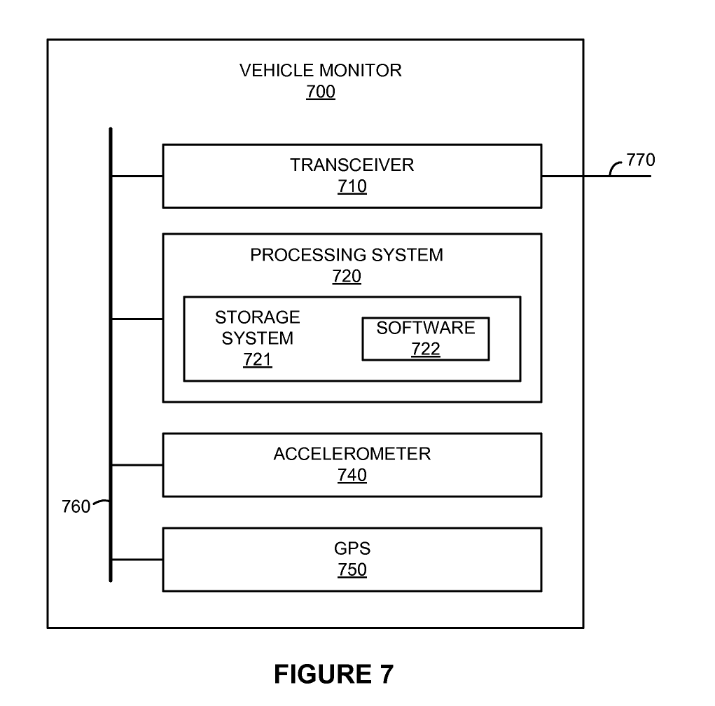

FIG. 7 is a block diagram illustrating vehicle monitor device 700, as an example of vehicle monitor 120 found in FIG. 1 or vehicle monitor 320 found in FIG. 3, although vehicle monitor 120 or vehicle monitor 320 could use other configurations. Device 700 includes transceiver 710, processing system 720, accelerometer 740, and global positioning system (GPS) receiver 750. Transceiver 710, processing system 720, accelerometer 740, and GPS 750 communicate over bus 760. Device 700 may be distributed or consolidated among devices that together form elements 610, 620-622, 640, 650, 660, and 670.

Transceiver 710 may include radio frequency (RF) communication circuitry and antenna elements. Transceiver 710 could also include amplifiers, filters, modulators, and signal processing circuitry. In this example, transceiver 710 can exchange instructions and information with processing system 720. Transceiver 710 also communicates with wireless access nodes and systems, such as base stations, omitted for clarity, over wireless link 770, to access communication services and exchange communications of the communication services. Wireless link 770 could use various protocols or communication formats as described herein for wireless link 161 or 370-371, 375, including combinations, variations, or improvements thereof. Device 700 and/or transceiver portion 710 may also include Bluetooth capability.

Vehicle monitor 700 could also include Bluetooth sensing and/or communication capability, an accelerometer, GPS functionality, cellular communication capability, flash memory, a processor, a real-time operating system, along with other functionality. Vehicle monitor 720 may also include a sensor to sense signal strength from one or more wireless communication devices 121, 321. In an example, vehicle monitor 700 may also be configured to receive power from the OBD port of a vehicle. In an example, vehicle monitor 700 may not be capable of receiving information from the OBD port of the vehicle.

Processing system 720 includes storage system 721. Processing system 720 retrieves and executes software 722 from storage system 721. Processing system 720 could incorporate a computer microprocessor, logic circuit, or some other processing device, and may be distributed among multiple processing devices. Processing system 720 could be located within the same equipment or circuitry in which transceiver 710, accelerometer 740, or GPS 750 are located. Storage system 721 could include computer-readable media such as disks, tapes, integrated circuits, servers, or some other memory device, and also may be distributed among multiple memory devices.

Software 722 may include a real-time operating system, logs, utilities, drivers, networking software, and other software typically loaded onto a computer system. Software 722 could contain an application program, firmware, or some other form of computer-readable instructions. When executed by processing system 720, software 722 may direct vehicle monitor 700 (120, 320) to operate as described herein.

Accelerometer 740 includes circuitry to detect and monitor acceleration of device 700. This circuitry could include sensors, micro-electromechanical sensors (MEMS), optics, gyroscopes, inertial masses, amplifiers, conditioners, analog-to-digital converters, digital-to-analog converters, logic, or microprocessors, among other circuitry. Accelerometer 740 provides acceleration information over bus 750 to processing system 720 or transceiver 720.

Global positioning system (GPS) receiver 750 includes circuitry and antennas to receive and interpret signals from positioning satellites to determine geographic coordinates of device 700. This circuitry could include sensors, amplifiers, conditioners, analog-to-digital converters, digital-to-analog converters, logic, or microprocessors, among other circuitry. GPS 750 provides positioning or location information over bus 750 to processing system 720 or transceiver 710.

Bus 760 comprises a physical, logical, or virtual communication link, capable of communicating data, control signals, communications, and power, along with other information and signals. In some examples, bus 760 is encapsulated within the elements of transceiver 710, processing system 720, accelerometer 740, or GPS 750, and may be a software or logical link. In other examples, bus 760 uses various communication media, such as air, space, metal, optical fiber, or some other signal propagation path, including combinations thereof. Bus 760 could be a direct link or might include various equipment, intermediate components, systems, and networks.

Device 700 may include a sensor for sensing cellular, Bluetooth, satellite, or any other type of signal, including relative signal strength. Device 700 may also be capable of accomplishing some or all of the functionality of collection node 150 found in FIG. 1 or collection node 350.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A method of operating a vehicle monitoring system, comprising:
receiving activity information related to a vehicle at a vehicle monitoring system, from a vehicle monitor adjacent the vehicle;
receiving information from one or more wireless communication devices associated with the vehicle at the vehicle monitoring system;
processing the activity information and the information from the one or more wireless communication devices to determine behavior of a driver operating the vehicle.

2. The method of claim 1, further comprising:
processing the information from the one or more wireless communication devices to identify a particular wireless communication device generally associated with the driver operating the vehicle.

3. The method of claim 2, wherein the identification a wireless communication device generally associated with the driver of the vehicle is based at least in part on information received from sources other than the wireless communication device generally associated with the driver of the vehicle and the vehicle monitor.

4. The method of claim 1, wherein the information from the one or more wireless communication devices comprises signal strength from the one or more wireless communication devices.

5. The method of claim 4, wherein the signal strength from the one or more wireless communication devices comprises blue-tooth type signal strength measured at the vehicle monitor.

6. The method of claim 1, wherein the activity information and the information from the one or more wireless communication devices are processed to determine when the driver was engaged in an activity on the wireless communication device during the occurrence of a driving event or when the vehicle is in motion.

7. The method of claim 1, wherein the wireless communication device comprises a multi-function mobile telephone.

8. A vehicle monitoring system, comprising:
a communication interface configured to receive activity information for a vehicle from a vehicle monitor and/or a wireless communication device;
the communication interface configured to receive information from the one or more wireless communication devices associated with the vehicle transferred by a communication network;
a processing system configured to process the activity information and the information from the one or more wireless communication devices to determine behavior of a driver operating the vehicle.

9. The vehicle monitoring system of claim 8, wherein the processing system is configured to process the activity information and/or the information from the one or more wireless communication devices to identify a wireless communication device generally associated with the driver of the vehicle.

10. The vehicle monitoring system of claim 9, wherein the identification a wireless communication device generally associated with the driver of the vehicle is based at least in part on information received from sources other than the wireless communication device generally associated with the driver of the vehicle and the vehicle monitor.

11. The vehicle monitoring system of claim 8, wherein the processing system is configured to determine the behavior of the driver during driving incidents of the vehicle based at least in part on the activity information and/or the information from the one or more wireless communication devices.

12. The vehicle monitoring system of claim 8, wherein the information from the one or more wireless communication devices comprises signal strength from the one or more wireless communication devices.

13. The vehicle monitoring system of claim 12, wherein the signal strength from the one or more wireless communication devices comprises blue-tooth type signal strength measured at the vehicle monitor.

14. A non-volatile computer readable medium, having instructions stored thereon which if implemented by a processor, causes the processor to implement a method for operating a vehicle monitoring system, the method comprising:
processing data of a vehicle associated with a vehicle monitor, wherein the vehicle monitor is located within the vehicle;
processing information from the one or more wireless communication devices associated with the vehicle;
determining a wireless communication device generally associated with a driver of the vehicle based at least in part on the data of the vehicle and/or the information from the one or more wireless communication devices;
accumulating information about the driver and the vehicle.

15. The computer readable medium of claim 14, having instructions for wherein the information about the driver comprises information about use of the wireless communication device generally associated with the driver.

16. The computer readable medium of claim 14, having instructions for wherein the determining the driver is based at least in part on communication signal strength between the wireless communication device associated with the driver and the vehicle monitor.

17. The computer readable medium of claim 16, having instructions for wherein the signal strength from the one or more wireless communication devices comprises blue-tooth type signal strength measured at the vehicle monitor.

18. The computer readable medium of claim 14, having instructions for wherein the wireless communication device comprises a multi-function mobile telephone.

19. The computer readable medium of claim 14, having instructions for wherein the wireless communication device and the vehicle monitor are capable of communication with a collection node at least in part by cellular communication via a communication network.

20. The computer readable medium monitoring system of claim 14, having instructions for wherein the wireless communication device is capable of communication with the vehicle monitor at least in part via blue-tooth type communication.
